(19) United States
(12) Patent Application Publication
(10) Pub. No.: US 2023/0278501 A1
(43) Pub. Date: Sep. 7, 2023

(54) STORAGE SYSTEMS FOR A STORAGE COMPARTMENT OF A VEHICLE

(71) Applicant: ABC Technologies Inc., Toronto (CA)

(72) Inventors: Harman GILL, Brampton (CA); Avinash JAYAKUMAR, Mississauga (CA); Usman DULATOV, Newmarket (CA)

(21) Appl. No.: 18/178,930

(22) Filed: Mar. 6, 2023

Related U.S. Application Data
(60) Provisional application No. 63/317,228, filed on Mar. 7, 2022.

(51) Int. Cl. B60R 5/02

(52) U.S. Cl. CPC B60R 5/02

(57) ABSTRACT

Provided is a cargo storage system for a forward compartment of a vehicle. The cargo storage system includes a support frame having a plurality of separate frame units, and a load floor supported upon the frame units. The support frame is mountable upon a trunk bin or body-in-white structure of the vehicle, and the placement of the load floor upon the frame units divides the forward compartment into a load floor cargo area in an area above the load floor, and a sub-floor cargo area in an area below the load floor.

### CROSS-REFERENCE TO RELATED APPLICATIONS

This application claims the benefit of U.S. Provisional Patent Application Ser. No. 63/317,228, filed Mar. 7, 2022, which is hereby incorporated by reference in its entirety for all purposes.

### FIELD OF THE INVENTION

The present invention relates to storage systems for a vehicle, and in particular to storage systems configured for use in a storage compartment of a vehicle.

### BACKGROUND

Automotive design is an ever-changing reality, with the continuous introduction of novel structural, functional, and aesthetic enhancements. Continuous improvements have also been central to the evolution of traditional propulsion systems, largely based around the internal combustion (IC) engine. The industry is now seeing a fundamental shift in respect of propulsion systems, with the goal of reducing and/or replacing the traditional IC engine with environmentally friendly options. One such example is the move towards propulsion systems based on the use of electric motors.

Vehicles of this type, generally referred to as electric vehicles (EV) implement a different arrangement of propulsion system components. While a conventional IC powered vehicle would have the IC engine located towards the front of the vehicle, the arrangement of propulsion system components in an EV generally results in the front region of the vehicle being largely unused, and therein presenting a space similar to that of a vehicle trunk. This ‘front trunk’ area of the vehicle, also referred to as a ‘frank’, presents an opportunity for additional cargo storage handling capacity.

It is evident that the aforementioned ‘front trunk’ is well suited to the implementation of cargo storage solutions, to enhance the cargo carrying capacity and usability of this space. As such, there is clearly a need in the industry for novel developments in this regard.

### SUMMARY OF THE INVENTION

According to an aspect of an embodiment, provided is a cargo storage system for a vehicle. The cargo storage system includes a support frame having a plurality of separate frame units and a load floor supported upon the frame units. The support frame is mountable upon a trunk bin or body-in-white structure of the vehicle.

According to another aspect of an embodiment, provided is a cargo storage system for a vehicle. The cargo storage system includes a support frame having first and second folding frame units and a load floor supported upon the first and second folding frame units. The first and second folding frame units are mountable upon a trunk bin or body-in-white structure of the vehicle.

According to a yet another aspect of an embodiment, provided is a cargo storage system for a vehicle. The cargo storage system includes a support frame having wall elements including a forward wall, a rearward wall, a first side wall and a second side wall, and a load floor supported upon the wall elements. The load floor is configured to be hinged and slidable relative to the support frame.

According to another aspect of an embodiment, provided is a cargo storage system for a forward compartment of a vehicle. The cargo storage system comprises a support frame having a plurality of separate frame units, and a load floor supported upon the frame units. The support frame is mountable upon a trunk bin or body-in-white structure of the vehicle, and the placement of the load floor upon the frame units divides the forward compartment into a load floor cargo area in an area above the load floor, and a sub-floor cargo area in an area below the load floor.

According to another aspect of an embodiment, provided is a cargo storage system for a forward compartment of a vehicle. The cargo storage system comprises a support frame having a first folding frame unit and a second folding frame unit, and a load floor supported upon the first and second folding frame units. The first and second folding frame units are mountable upon a trunk bin or body-in-white structure of the vehicle. The placement of the load floor upon the frame units divides the forward compartment into a load floor cargo area in an area above the load floor, and a sub-floor cargo area in an area below the load floor.

According to another aspect of an embodiment, provided is a cargo storage system for a forward compartment of a vehicle. The cargo storage system comprises a support frame having wall elements including a forward wall, a rearward wall, a first side wall and a second side wall. The cargo storage system also includes a load floor supported upon the wall elements, the load floor being configured to be hinged and slidable relative to the support frame. The support frame is mountable upon a trunk bin or body-in-white structure of the vehicle. The placement of the load floor upon the support frame divides the forward compartment into a load floor cargo area in an area above the load floor, and a sub-floor cargo area in an area below the load floor.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIGS. 1 and 2 illustrate a partial perspective view of a front portion of a vehicle, showing a first embodiment of a cargo storage system.

FIGS. 3 and 4 illustrate a partial perspective view of a front portion of a vehicle, showing another embodiment of a cargo storage system having side storage compartments.

FIG. 5 is a partial perspective view of the cargo storage system of FIG. 3 with an alternative load floor arrangement.

FIGS. 6 and 6a illustrate a partial perspective view of the cargo storage system of FIG. 3 with another alternative load floor arrangement.

FIGS. 6b through 6d illustrate an alternative arrangement of the cargo storage system of FIG. 6, with the addition of a lock feature for maintaining the first and second side panels in an upright orientation.

FIGS. 7 to 13 illustrate a partial perspective view of a front portion of a vehicle, showing a further alternative embodiment of a cargo storage system having a multi-panel stowable load floor and a folding frame.

FIGS. 14 to 16 illustrate a partial perspective view of a front portion of a vehicle, showing a further alternative embodiment of a cargo storage system having a hinged and slidable load floor.

FIGS. 17 to 21 illustrate a partial perspective view of a front portion of a vehicle, showing a further alternative embodiment of a cargo storage system having a load floor with an array of top-side attachment features.

### DESCRIPTION OF THE EMBODIMENTS

The following detailed description is merely exemplary in nature and is not intended to limit the disclosure or the application and uses of the disclosure. A person skilled in the relevant art will recognize that other configurations and arrangements can be used without departing from the scope of the disclosure. Furthermore, there is no intention to be bound by any expressed or implied theory presented in the preceding technical field, background, brief summary, or the following detailed description.

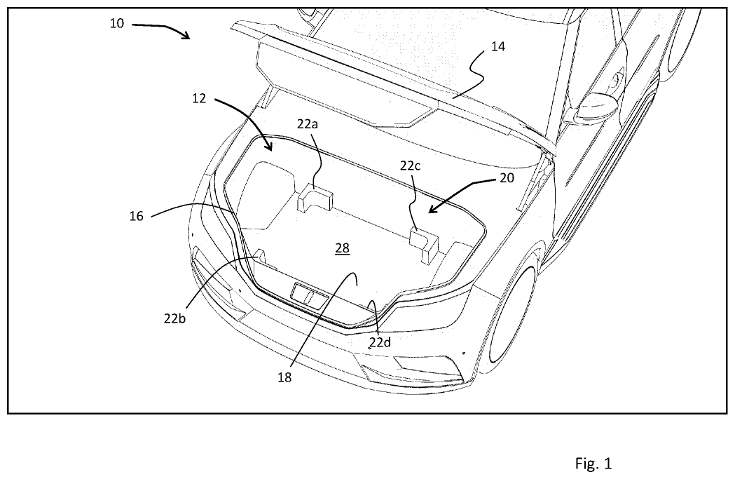

With reference now to FIG. 1, shown is a front region of a vehicle 10. Similar to conventional vehicles with an internal combustion (IC) engine, the front region includes a forward compartment 12 enclosed by a hood 14 and surrounding vehicle structure 16. While the forward compartment 12 in an IC vehicle is customarily used to house the engine, the forward compartment 12 (i.e. front trunk) of an electric or rear engine vehicle is generally intended for use as a cargo storage area. The forward compartment may include a front trunk bin 18, to cover elements of the body-in-white, therein presenting a more aesthetically pleasing appearance.

Continuing with FIG. 1, the forward compartment 12 of the vehicle is shown to house a cargo storage system 20, to facilitate the storage and handling of cargo items contained therein. The cargo storage system 20 is shown to include a support frame including a plurality of separate frame units. As shown, the support frame includes a first frame unit 22a, a second frame unit 22b, a third frame unit 22c, and a fourth frame unit 22d (herein collectively referred to as frame units 22).

Where a front trunk bin 18 is provided, the frame units 22 are attached to either the front trunk bin 18 itself, or the vehicle body-in-white metal frame structure behind/underneath the front trunk bin 18. Where a front trunk bin 18 is not provided, the frame units are attached directly to the vehicle body-in-white. The attachment of the frame units 22 may be facilitated through the use of snap fits, tongue-and-groove, mechanical fastener clips, threaded fasteners (i.e. screws) or similar attachment schemes that allow the frame units 22 to be fixedly attached to the respective receiving surface.

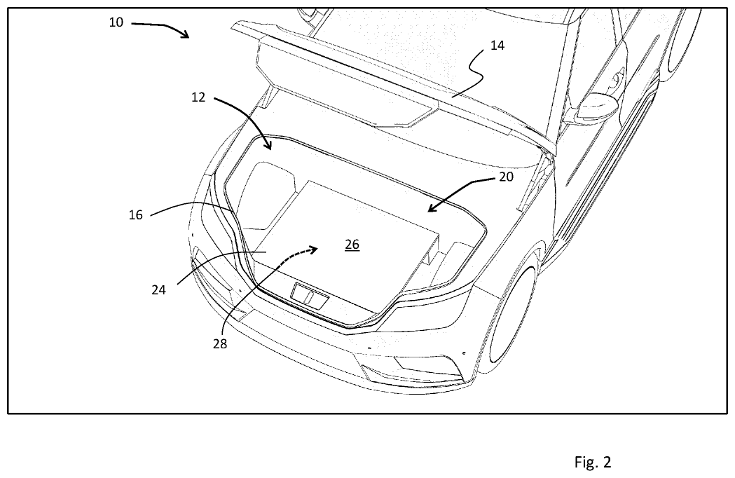

The support frame defined by the frame units 22 collectively serve as a support system to support the level positioning of a cargo load floor placed on top of it. With reference to FIG. 2, a load floor 24 is shown supported upon the frame units 22. To facilitate the correct positioning and/or secure attachment of the load floor 24 upon the frame units 22, the interface therebetween may include additional features such as holes, key-hole slots, or debossed grooves. The additional features may be added to either of, or both of the load floor 24 and the frame units 22 in a manner that permits cooperative action therebetween. When the load floor 24 is placed upon the frame units 22, the load floor 24 effectively divides the forward compartment 12 into 2 areas (i.e. within the bounds of the load floor foot print), namely a load floor cargo area 26 in the area above the load floor 24, and a sub-floor cargo area 28 in the area below the load floor 24.

It will be appreciated that the frame units 22 may be configured to be detachable/removeable from the front trunk bin 18, or the body-in-white metal frame structure, and may further be configured to be repositionable within the forward compartment 12. This functionality would permit for some adjustability in the positioning of the load floor 24, or alternatively permit for the complete removal of the cargo storage system 20, therein allowing the use of a larger storage volume offered by the entire forward compartment 12.

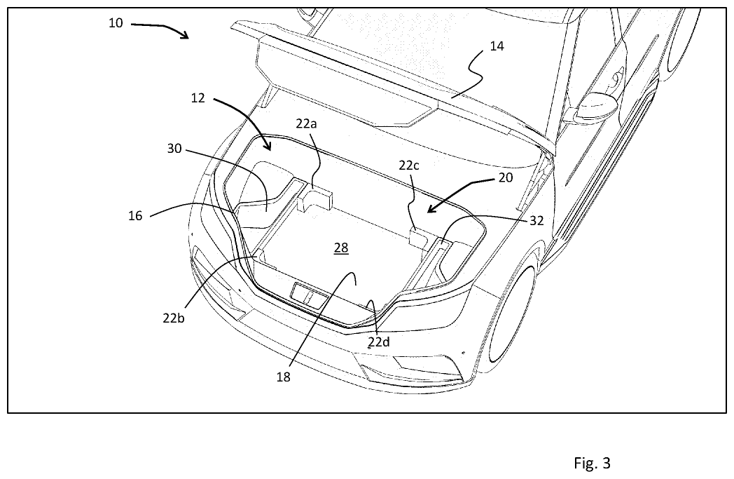

Referring now to FIG. 3, shown is the cargo storage system 20 with the addition of a first side storage compartment 30 and a second side storage compartment 32. As specifically shown, the first side storage compartment 30 is positioned in a storage cavity adjacent to the first and second frame units 22a, 22b, while the second side storage compartment 32 is positioned in a storage cavity adjacent to the third and fourth frame units 22c, 22d. The first and second side storage compartments 30, 32 may be either fixedly or removably installed in their respective positions. Similar to the frame units 22, attachment of the first and second side storage compartments 30, 32 may be facilitated through the use of snap fits, tongue-and-groove, mechanical fastener clips, threaded fasteners (i.e. screws) or similar attachment schemes that allow the first and second side storage compartments to be operable in the selected manner, that is either as fixed or removeable storage unit. Also similar to the frame units 22, the first and second side storage compartments 30, 32 may be configured for either fixed or releasable attachment to the front trunk bin 18, the body-in-white metal frame structure of the vehicle, or the adjacent frame units 22.

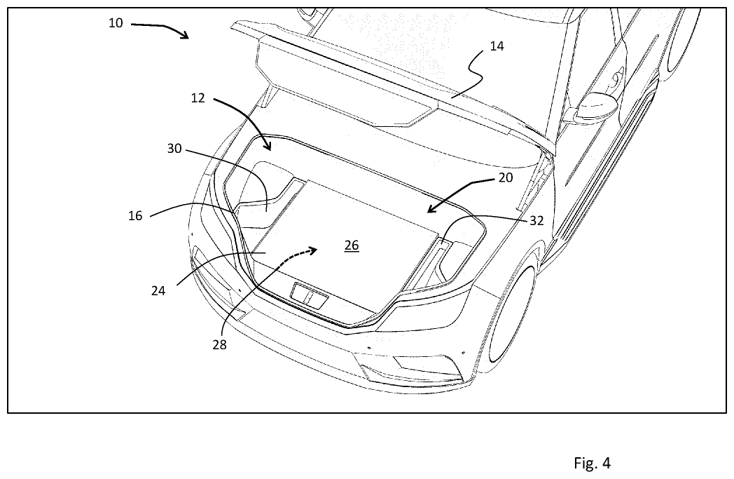

With reference to FIG. 4, the first and second side storage compartments 30, 32 are positioned in a way that places them outside the bounds of the load floor footprint, but within the volume of the forward compartment 12. With this arrangement, the first and second side storage compartments 30, 32 remain accessible even when the load floor 24 is positioned upon the frame units 22.

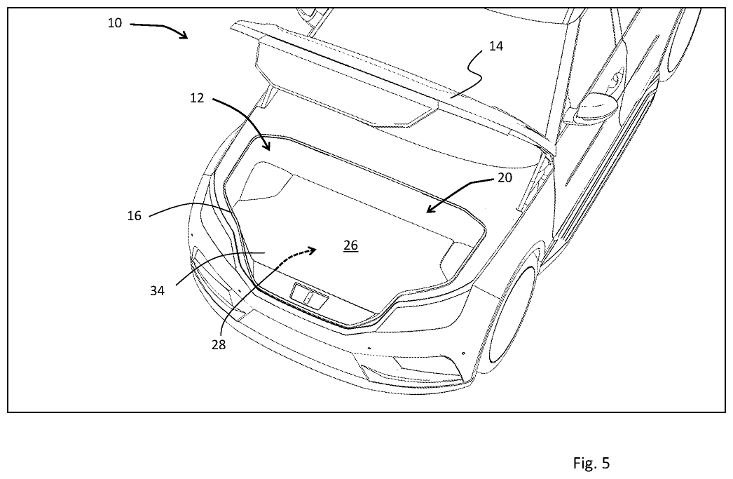

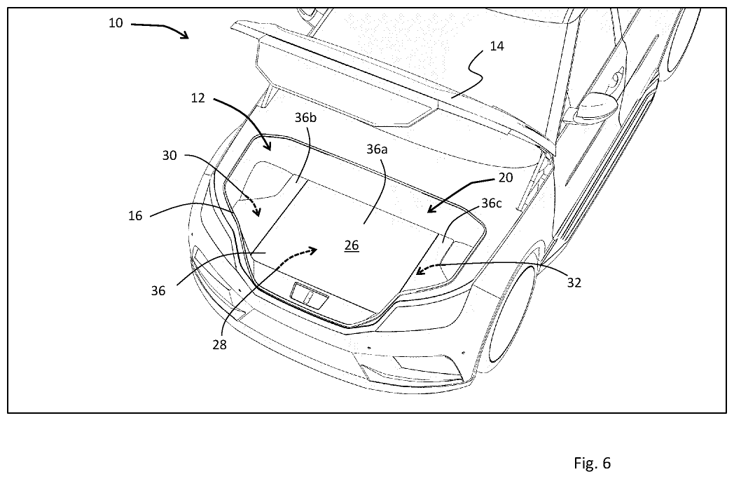

In another embodiment, the load floor may be dimensioned in a manner that fully covers the sub-floor cargo area 28 delimited by the frame units 22, and the first and second side storage compartments 30, 32, as shown for example in FIG. 5. In this case, the load floor 34 is a singular one-piece structure.

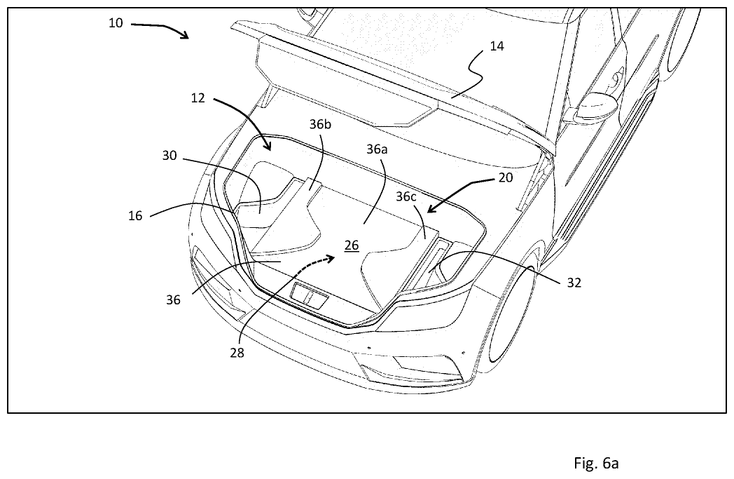

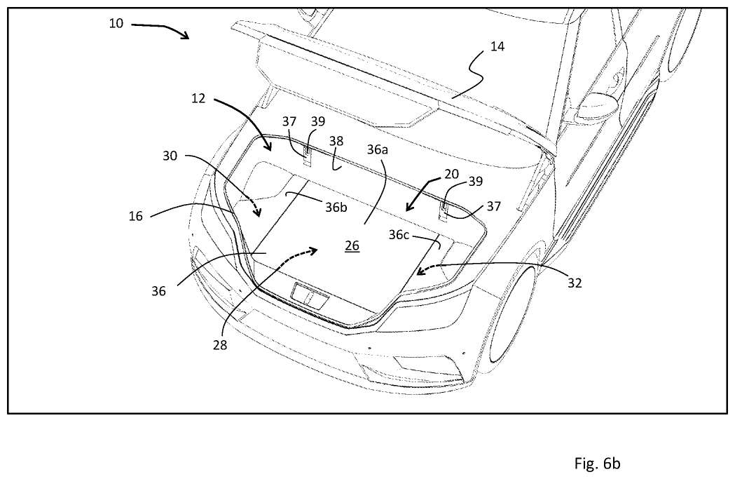

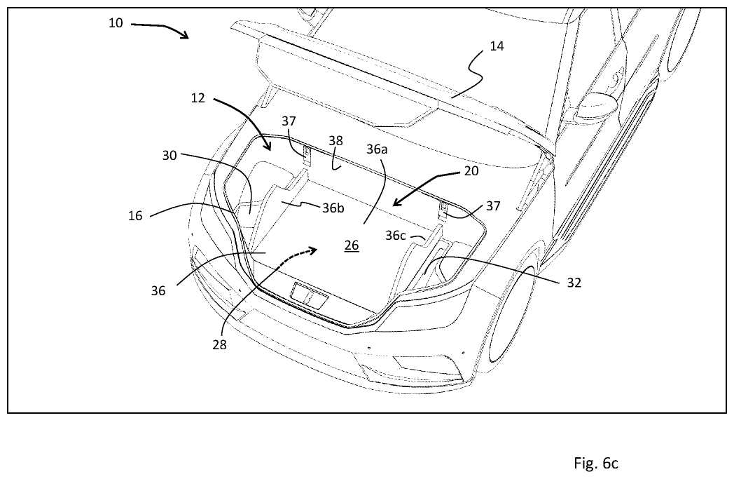

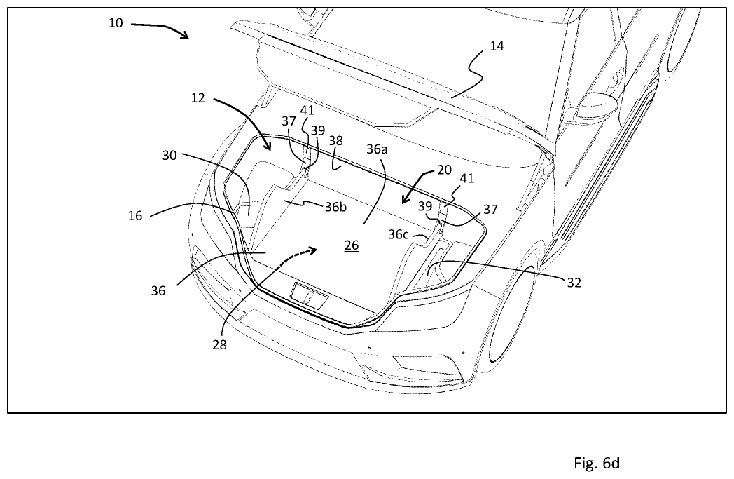

In yet another embodiment, the load floor may be configured as a multi-panel assembly, that cooperatively serve to fully cover the sub-floor cargo area 28 delimited by the frame units 22, and the first and second side storage compartments 30, 32. This arrangement is shown in FIG. 6, where the load floor 36 includes a central panel 36a that covers the sub-floor cargo area 28, a first side panel 36b that covers the first side storage compartment 30, and a second side panel 36c that covers the second side storage compartment 32. Each of the first and second side panels 36b, 36c may be separately openable/removeable relative to the central panel 36a. The first and second side panels 36b, 36c may be configured to snap, clip or otherwise mechanically interface with the central panel 36a at the respective interface therebetween. Alternatively, the first and second side panels 36b, 36c may be hingedly connected at the respective interface, either through the use of one or more separately formed hinges, or through the use of a living hinge formed during the manufacturing process of the load floor assembly.

With reference now to FIGS. 6b to 6d, shown is a similar arrangement where the cargo storage system 20 includes a means to maintain the first and second side panels 36b, 36c in an intermediate upright orientation. As shown, the load floor 36 is similarly configured with the central panel 36a, and first and second side panels 36b, 36c. The first and second side panels 36b, 36c may be separately openable/removeable relative to the central panel 36a, or hinged, once again as previously described. In this particular arrangement, the cargo storage system 20 additionally includes a lock element 37 positioned on the rearward wall 38 of the front trunk bin 18, proximal each of the first and second side panels 36b, 36c. Each of the lock elements 37 is rotatable from a stowed position, as shown in FIGS. 6b, 6c, to a deployed position as shown in FIG. 6d. In the deployed position, each of the lock elements 37 capture the respective uprightly oriented first and second side panels 36b, 36c using a slot 39. In this way, items that may be placed within the load floor cargo area 26 are restricted to the area directly above the central panel 36a. It will be noted that each of the lock elements 37 are located within a respective recess 41 when in the stowed position. It will be appreciated that while the lock element 37 is shown as a mean to maintain the first and second side panels 36a, 36b in the uprightly oriented position, other means may be used to achieve this functionality.

The frame units 22 may be made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the frame units. The frame units may additionally include features that serve to provide structural reinforcement or light-weighting characteristics, such as the use of honeycomb reinforcement ribbing.

The frame units may be manufactured by one or more manufacturing methods including, but not limited to, injection molding, compression molding, thermoforming, stamping, compression/thermoformed, vacuum forming, CNC milling, extrusion, blow-molding, casting, etc.

The load floors may be made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the load floors. The load floors may additionally include features that serve to provide structural reinforcement or light-weighting characteristics, such as the use of honeycomb reinforcement ribbing.

The load floors may be manufactured by one or more manufacturing methods including, but not limited to, injection molding, compression molding, thermoforming, stamping, compression/thermoformed, vacuum forming, CNC milling, extrusion, blow-molding, casting, etc.

The load floors may be covered in textile or non-woven textile type or fabric materials including but not limited to PET non-woven fibers, hard plastic skins such as TPO/TPE, laminate films, wood grain, metallic sheets, or rubber/rubberized material.

Where the arrangement and functionality of the load floor permits, the load floor may be configured to be reversible, that is with two usable sides. While both sides may be covered with the same material (i.e. carpet), it is also contemplated that the load floor may be configured on a first side surface with a carpet, and on the opposing side surface with a rubberized cover.

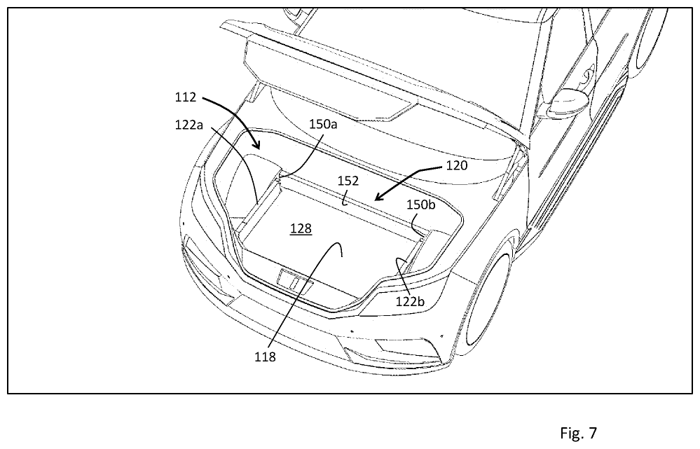

Turning now to FIG. 7, shown is an alternative embodiment of a cargo storage system 120 for use in the forward compartment 112 of a vehicle. The cargo storage system 120 is shown to include a support frame including a first folding frame unit 122a, and a second folding frame unit 122b (herein collectively referred to as folding frame units 122); the folding functionality of the folding frame units 122 to be described in greater detail below.

The folding frame units 122 are attached to either a front trunk bin 118 lining the forward compartment 112, or the vehicle body-in-white metal frame structure behind/underneath the front trunk bin 118. Where a front trunk bin 118 is not provided, the folding frame units 122 are attached directly to the vehicle body-in-white. The attachment of the folding frame units 122 may be facilitated through the use of snap fits, tongue-and-groove, mechanical fastener clips, threaded fasteners (i.e. screws) or similar attachment schemes that allow the folding frame units 122 to be fixedly attached to the respective receiving surface.

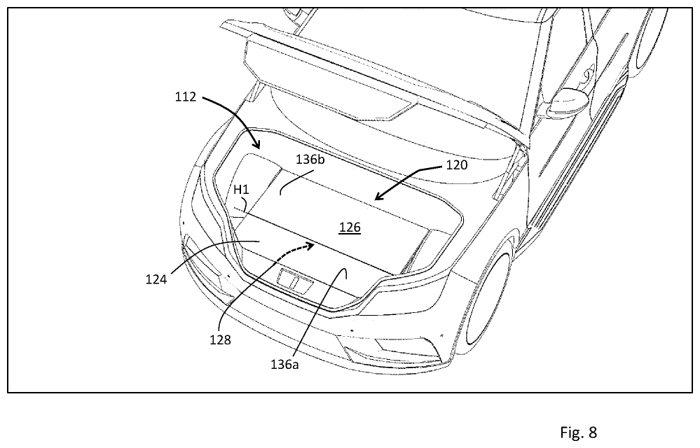

The support frame defined by the folding frame units 122 collectively serve as a support system to support the level positioning of a cargo load floor placed on top of it. With reference to FIG. 8, a load floor 124 is shown supported upon the folding frame units 122. To facilitate the correct positioning and/or secure attachment of the load floor 124 upon the folding frame units 122, the interface therebetween may include additional features such as holes, key-hole slots, or debossed grooves. The additional features may be added to either of, or both of the load floor 124 and the folding frame units 122 in a manner that permits cooperative action therebetween. When the load floor 124 is placed upon the frame units 122, the load floor 124 effectively divides the forward compartment 112 into 2 areas (i.e. within the bounds of the load floor foot print), namely a load floor cargo area 126 in the area above the load floor 124, and a sub-floor cargo area 128 in the area below the load floor 124.

Continuing with FIG. 8, the load floor 124 is shown to be configured as a multi-panel assembly, that cooperatively serve to fully cover the sub-floor cargo area 128 delimited by the folding frame units 122. In this arrangement, the load floor 124 includes a first panel 136a and a second panel 136b that are hingedly connected at the interface therebetween, either through the use of one or more separately formed hinges, or through the use of a living hinge formed during the manufacturing process of the load floor assembly.

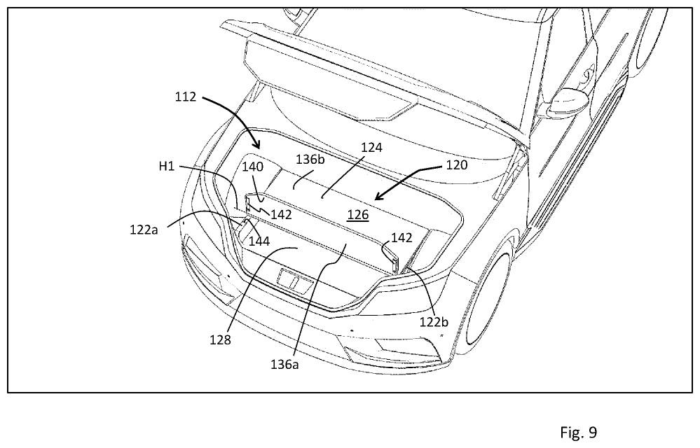

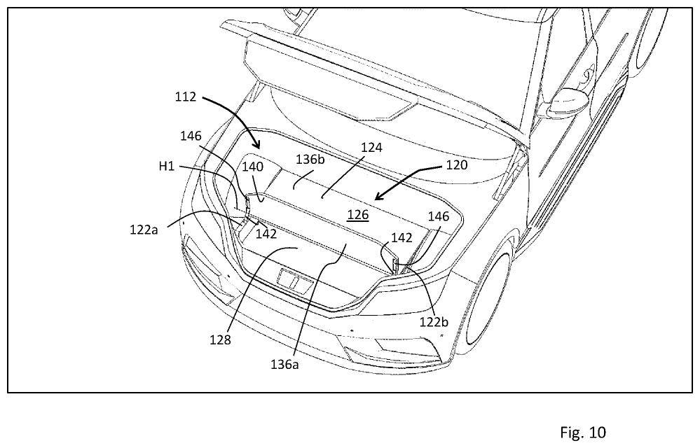

The hinged connection permits the first panel 136a to be rotatable about the hinge axis H1 from a horizontal orientation as shown in FIG. 8, to an upright orientation as shown in FIG. 9. To maintain the first panel 136a in the upright orientation, a bottom face 140 of the first panel 136a may be configured with a small bar, key-hole, peg, hook or other suitable feature that facilitates the attachment of a support arm 142 on one or both sides of the bottom face 140 of the first panel 136a. The support arm 142 may be deployed as shown in FIG. 10 to engage a corresponding recess 144 provided or formed on the folding frame units 122. In the upright orientation, the first panel 136a may serve as a divider to prevent cargo items stored on the rearward half of the load floor from sliding around the full cargo volume. The upright orientation of the first panel 136a also provides access to the sub-floor cargo area 128. When not in use, the support arm 142 may be folded into a recess 146 provided or formed on the bottom face 140 of the first panel 136a.

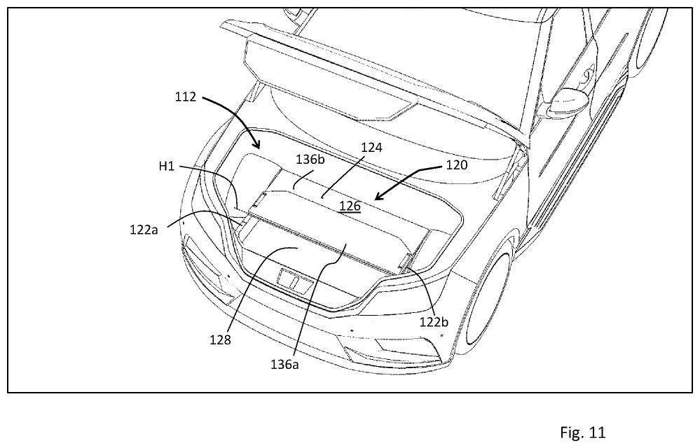

With reference now to FIG. 11, the hinged connection between the first and second panels 136a, 136b additionally permits the first panel 136a to extend beyond the upright orientation and fully fold upon the second panel 136b. In this way, the effective load bearing area of the load floor 124 is reduced, for example by half where the first and second panels 136a, 136b are of roughly equal dimensional area. As specifically shown in FIG. 11, the effective load bearing area of the load floor 124 is reduced by 40%.

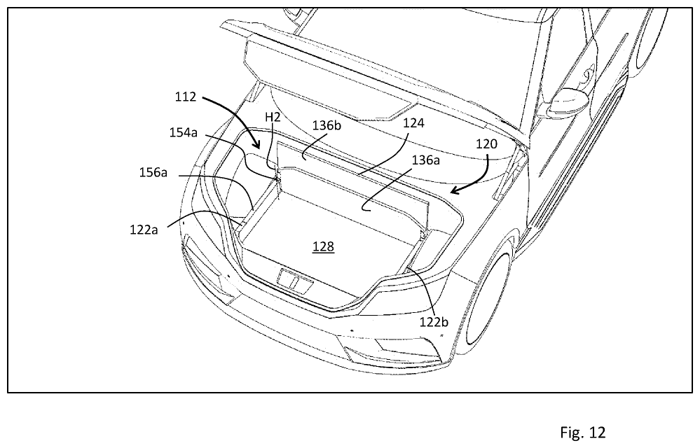

With the first panel 136a fully folded upon the second panel 136b as shown in FIG. 11, the load floor 124 can be lifted and repositioned in an upright orientation towards the rear of the cargo storage system 120. This arrangement is shown in FIG. 12. To maintain the load floor 124 in the upright orientation, the load floor 124 may be seated in opposing first and second side pockets 150a, 150b (best seen in FIG. 7) formed between the rear portions of each folding frame unit 122 and a rear wall 152. In this way, the sub-floor cargo area 128 is fully exposed and available for cargo storage.

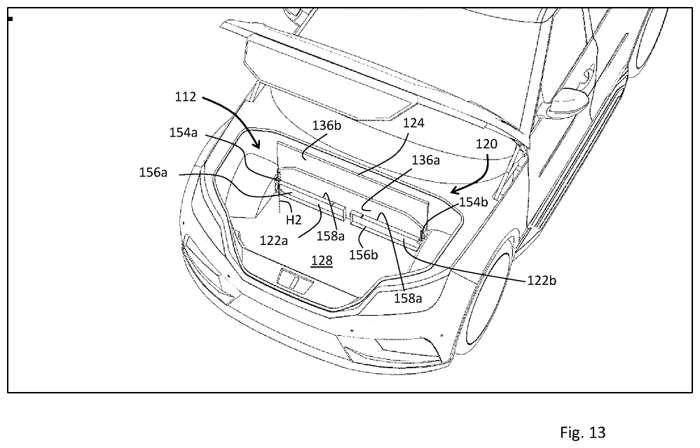

Additional cargo storage can be achieved through the folding functionality of the folding frame units 122. With specific reference to the first folding frame unit 122a, the unit is shown to include a stationary portion 154a and a moveable forward portion 156a. The stationary portion 154a and the moveable forward portion 156a are hingedly connected, permitting the forward portion 156a to rotate about a hinge axis H2 from a deployed position as shown in FIG. 7, to a stowed position as shown in FIG. 13. The rotation of the forward portion 156a to the stowed position additionally serves to retain the load floor 124 in the upright orientation, by establishing an extended storage pocket 158a. As the above was exemplified based on the folding functionality of the first folding frame unit 122a, it will be appreciated that the second folding frame unit 122b is similarly configured with a stationary portion 154b, a moveable forward portion 156b, and an extended storage pocket 158b.

The folding frame units 122 may be made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the folding frame units 122. The folding frame units 122 may additionally include features that serve to provide structural reinforcement or light-weighting characteristics, such as the use of honeycomb reinforcement ribbing.

The folding frame units 122 may be manufactured by one or more manufacturing methods including, but not limited to, injection molding, compression molding, thermoforming, stamping, compression/thermoformed, vacuum forming, CNC milling, extrusion, blow-molding, casting, etc.

The load floors may be made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the load floors. The load floors may additionally include features that serve to provide structural reinforcement or light-weighting characteristics, such as the use of honeycomb reinforcement ribbing.

The load floors may be manufactured by one or more manufacturing methods including, but not limited to, injection molding, compression molding, thermoforming, stamping, compression/thermoformed, vacuum forming, CNC milling, extrusion, blow-molding, casting, etc.

The load floors may be covered in textile or non-woven textile type or fabric materials including but not limited to PET non-woven fibers, hard plastic skins such as TPO/TPE, laminate films, wood grain, metallic sheets, or rubber/rubberized material.

Where the arrangement and functionality of the load floor permits, the load floor may be configured to be reversible, that is with two usable sides. While both sides may be covered with the same material (i.e. carpet), it is also contemplated that the load floor may be configured on a first side surface with a carpet, and on the opposing side surface with a rubberized cover.

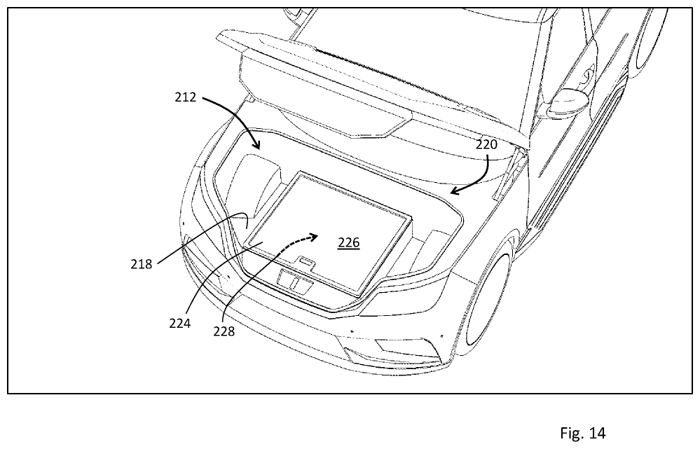

Turning now to FIG. 14, shown is a further alternative embodiment of a cargo storage system 220 for use in the forward compartment 212 of a vehicle. The cargo storage system 220 is shown to include a support frame having a forward wall 222a, a rearward wall 222b, a first side wall 222c and a second side wall 222d (collectively referred to herein as wall elements 222). The arrangement of the wall elements 222 may be provided in the form of a unitary structure, or may be provided in separately formed units.

Regardless of the arrangement, the wall elements 222 are attached to either a front trunk bin 218 lining the forward compartment 212, or the vehicle body-in-white metal frame structure behind/underneath the front trunk bin 218. Where a front trunk bin 218 is not provided, the wall elements 222 are attached directly to the vehicle body-in-white. The attachment of the wall elements 222 may be facilitated through the use of snap fits, tongue-and-groove, mechanical fastener clips, threaded fasteners (i.e. screws) or similar attachment schemes that allow the support frame to be fixedly attached to the respective receiving surface.

The support frame defined by the various wall elements 222 collectively serve as a support system to support the level positioning of a cargo load floor 224 placed on top of it. To facilitate the correct positioning and/or secure attachment of the load floor 224 upon the wall elements 222, the interface therebetween may include additional features such as holes, key-hole slots, or debossed grooves. The additional features may be added to either of, or both of the load floor 224 and the wall elements 222 in a manner that permits cooperative action therebetween. When the load floor 224 is placed upon the wall elements 222, the load floor 224 effectively divides the forward compartment 212 into 2 areas (i.e. within the bounds of the load floor foot print), namely a load floor cargo area 226 in the area above the load floor 224, and a sub-floor cargo area 228 in the area below the load floor 224.

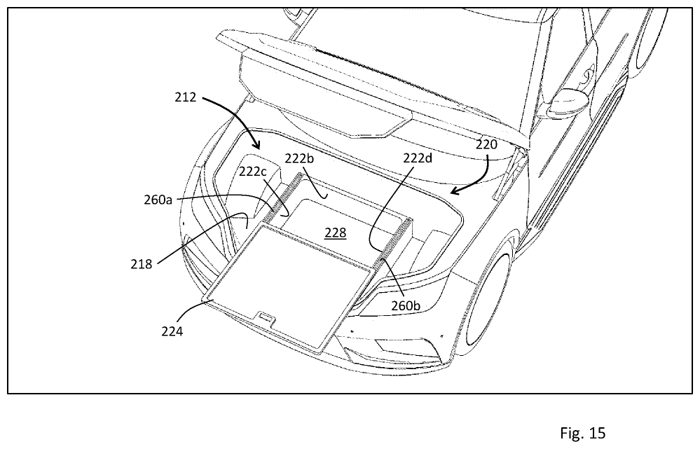

With reference now to FIG. 15, the load floor 224 is shown to be slidable upon the support frame in a manner similar to a sliding shelf. In this way, the load floor 224 may be arranged in a stowed position such as that shown in FIG. 14, as well as the deployed position, such as that shown in FIG. 15. The sliding interface between the load flood 224 and the support frame may be accomplished through the use of a slide cartridge (not shown) disposed or provided on the bottom-side of the load floor 224, proximal each side towards a rear portion thereof. Each slide cartridge is configured to cooperate with a slide rail disposed or provided on each of the first and second side walls 222c, 222d. As shown, the first side wall 222c includes a first slide rail 260a, while the second side wall 222d includes a second slide rail 260b. It will be appreciated that the bottom-side of the load floor 224 may include additional hardware, including but not limited to slide guides (not shown), to enhance the sliding action/alignment of the load floor 224 relative to the support frame.

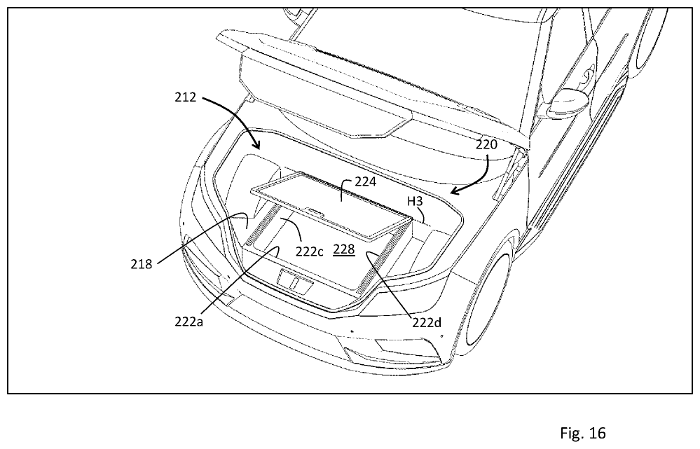

With reference to FIG. 16, the load floor 224 is also shown to be pivotable about hinge axis H3, enabling greater access to the sub-floor cargo area 228 in the area below the load floor 224. To achieve this, the slide cartridge may be configured with a first cartridge element that slidingly engages the respective slide rail, and a second cartridge element that is fixedly attached to the bottom-side surface of the load floor 224. The first and second cartridge elements are hingedly connected, therein defining the hinge axis H3 about which the load floor 224 rotates. In some arrangements, the slide cartridge may be configured to be rotatable about the hinge axis H3 only when the load floor 224 is in a predefined position, for example the fully stowed position as shown in FIG. 16.

The wall elements 222 making up the support frame made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the wall elements 222. The wall elements 222 may additionally include features that serve to provide structural reinforcement or light-weighting characteristics, such as the use of honeycomb reinforcement ribbing.

The wall elements 222 may be manufactured by one or more manufacturing methods including, but not limited to, injection molding, compression molding, thermoforming, stamping, compression/thermoformed, vacuum forming, CNC milling, extrusion, blow-molding, casting, etc.

The load floor 224 may be made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the load floors. The load floor may additionally include features that serve to provide structural reinforcement or light-weighting characteristics, such as the use of honeycomb reinforcement ribbing.

The load floor may be manufactured by one or more manufacturing methods including, but not limited to, injection molding, compression molding, thermoforming, stamping, compression/thermoformed, vacuum forming, CNC milling, extrusion, blow-molding, casting, etc.

The load floor may be covered in textile or non-woven textile type or fabric materials including but not limited to PET non-woven fibers, hard plastic skins such as TPO/TPE, laminate films, wood grain, metallic sheets, or rubber/rubberized material.

Where the arrangement and functionality of the load floor permits, the load floor may be configured to be reversible, that is with two usable sides. While both sides may be covered with the same material (i.e. carpet), it is also contemplated that the load floor may be configured on a first side surface with a carpet, and on the opposing side surface with a rubberized cover.

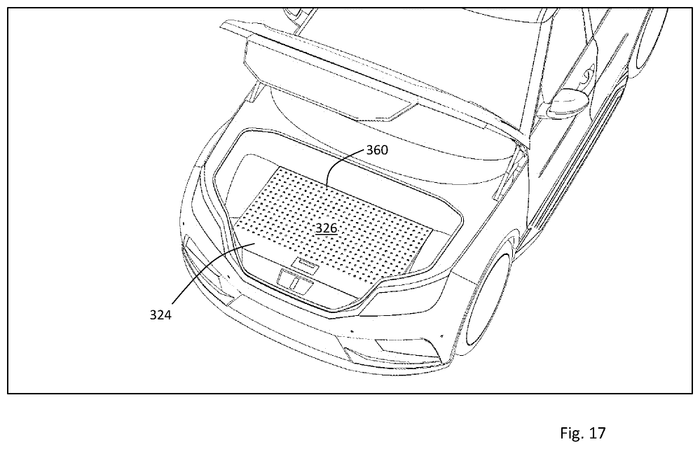

Turning now to FIG. 17, shown is an alternative embodiment of a load floor 324 that may find application with any of the cargo storage systems described above. While exemplified in the form of a singular unitary structure, it will be appreciated that the features described below may be applied to the multi-panel load floors previously described.

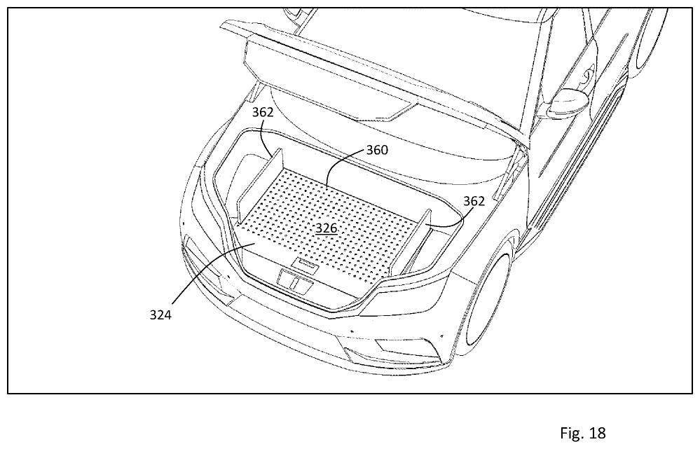

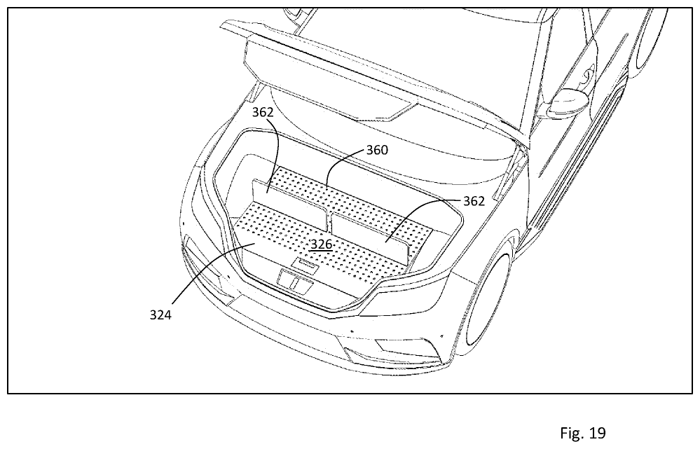

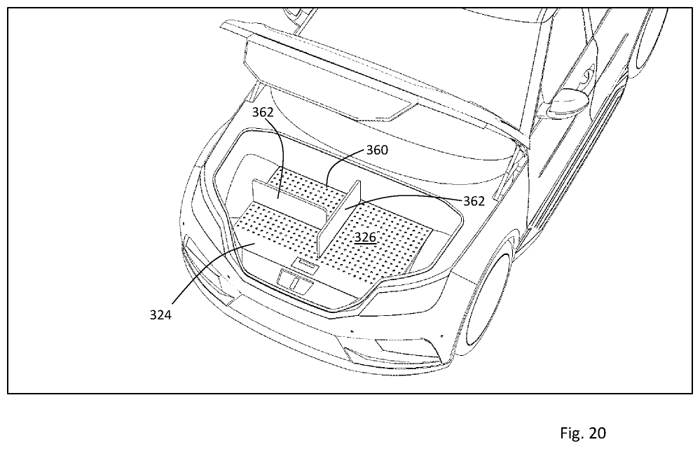

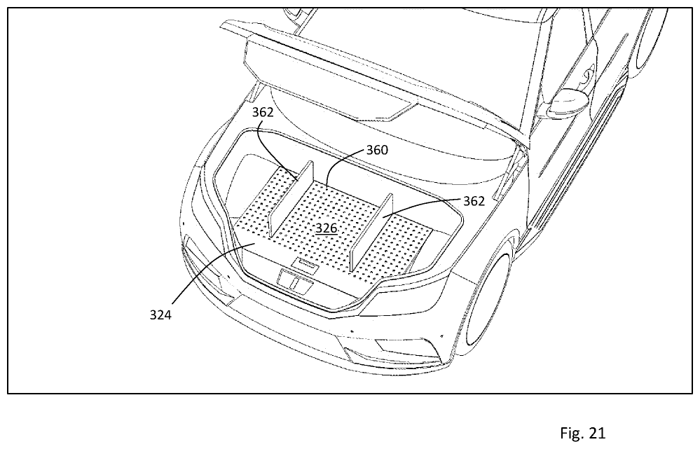

Unlike the previously described load floors, the load floor 324 includes a top-side surface that includes an array of attachment features 360 that mechanically engage cooperating attachment elements disposed or provided on one or more divider panels 362. Exemplary mechanical attachment may be achieved through the use of hooks, snaps, magnetic attachments, hook-and-loop fasteners, or other means of achieving a mechanical interconnect. The attachment features 360 may also include holes/recesses that receive cooperating pegs/protrusions disposed or provided along at least one edge of the divider panel 362. Regardless of the manner by which the divider panel 362 is attached to the load floor 324, the interconnection is configured to be releasable, therein enabling a user to modify the arrangement of the divider panels 362, permitting user customization of the load floor cargo area 326 in the area above the load floor 324. Exemplary arrangements for a pair of divider panels 360 is shown in FIGS. 18 to 21.

In some embodiments, lockable mechanical attachments may be incorporated to enable the divider panel 362 to be securely attached to the receiving load floor 324 until the user specifically releases the divider.

In addition to divider panels 362, the various mechanical attachment features/elements may be incorporated into the construction of other accessories including, but not limited to, trays, boxes, and tool carriers.

The load floor 324 and divider panels 360 may be made of materials including, but not limited to carbon steel, aluminum or its alloys, and/or engineered plastics including polyamide (PA), PE, HDPE, ABS, PC-ABS, PP, or glass-fiber or carbon fiber reinforced composites of such materials, or composite sandwich materials. Composite sandwich laminate structures such as reinforced paper, metal or polymer honeycomb boards (PCB) may also be used in the construction of the load floors and dividers. The load floor and dividers may additionally include features that serve to provide structural reinforcement or light-weighting characteristics, such as the use of honeycomb reinforcement ribbing.

The load floor and dividers may be manufactured by one or more manufacturing methods including, but not limited to, injection molding, compression molding, thermoforming, stamping, compression/thermoformed, vacuum forming, CNC milling, extrusion, blow-molding, casting, etc. The aforementioned attachment features and elements may either be assembled in a secondary process or be molded-in directly while manufacturing the respective component.

The load floor and dividers may be covered in textile or non-woven textile type or fabric materials including but not limited to PET non-woven fibers, hard plastic skins such as TPO/TPE, laminate films, wood grain, metallic sheets, or rubber/rubberized material.

Where the arrangement and functionality of the load floor permits, the load floor may be configured to be reversible, that is with two usable sides. While both sides may be covered with the same material (i.e. carpet), it is also contemplated that the load floor may be configured on a first side surface with a carpet, and on the opposing side surface with a rubberized cover.

While the various cargo storage system discussed above have been exemplified for use in a front trunk of a vehicle, the designs and functionality may also find application in a rear trunk of a vehicle.

It should be noted that in the description, terms such as forward, front and derivations of these terms are intended to mean or refer to an orientation directed towards, or a location situated towards, the front of the vehicle or component in question relative to its orientation within a vehicle. Similarly, terms such as rearward, rear and derivations of these terms are intended to mean or refer to an orientation directed towards, or a location situated towards, the back of the vehicle or component in question relative to its orientation within a vehicle. Terms such as up, upper, upward, top and derivations of these terms are intended to mean or refer to an orientation that is above or on a top side of the vehicle or component in question relative to its orientation within a vehicle. Terms such as lower, down, downward, bottom and derivations of these terms are intended to mean or refer to an orientation that is below or on a bottom side of the vehicle or component in question relative to its orientation within a vehicle. The term outer, outboard, outside and derivations of these terms is intended to mean or refer to an orientation directed towards, or a location situated outwardly from the side of the vehicle or component in question relative to its orientation within a vehicle. The term inner, inboard, inside and derivations of these terms is intended to mean or refer to an orientation directed towards, or a location situated towards a longitudinal centerline of the vehicle, or component in question relative to its orientation within a vehicle.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

1. A cargo storage system for a forward compartment of a vehicle, the cargo storage system comprising:
a support frame having a plurality of separate frame units; and
a load floor supported upon the frame units,
wherein the support frame is mountable upon a trunk bin or body-in-white structure of the vehicle, and
wherein the placement of the load floor upon the frame units divides the forward compartment into a load floor cargo area in an area above the load floor, and a sub-floor cargo area in an area below the load floor.

2. The cargo storage system according to claim 1, wherein the support frame includes four separate frame units, and correct positioning of the load floor upon the frame units is facilitated through the use of additional features added to at least one of the load floor and the frame units.

3. The cargo storage system according to claim 2, wherein the additional features are characterized as at least one of holes, key-hole slots, or debossed grooves.

4. The cargo storage system according to claim 1, further comprising a first side storage compartment and a second side storage compartment, wherein the first and second side storage compartments may be either fixedly attached or removably attached at their respective positions within the forward compartment.

5. The cargo storage system according to claim 4, wherein the first and second side storage compartments are positioned to remain outside the bounds of a footprint defined by the load floor, so as to keep the first and second side storage compartments accessible when the load floor in positioned upon the frame units.

6. The cargo storage system according to claim 4, wherein the load floor is dimensioned to cover the sub-floor cargo area delimited by the frame units and the first and second side storage compartments.

7. The cargo storage system according to claim 6, where in the load floor is configured as a one-piece panel.

8. The cargo storage system according to claim 6, wherein the load floor is configured as a multi-panel assembly that includes a central panel that covers the sub-floor cargo area, and first and second side panels that cover respective first and second side storage compartments.

9. The cargo storage system according to claim 1, wherein the load floor includes a top-side surface that includes an array of attachment features that facilitate mechanical attachment to cooperating attachment elements disposed one or more accessories affixable thereto.

10. The cargo storage system according to claim 9, wherein the mechanical attachment may be achieved through the use of at least one of hooks, snaps, magnetic attachments, hook-and-loop fasteners, or the use of holes/recesses provided on the top-side surface that receive cooperating pegs/protrusions disposed along at least one surface of the accessory.

11. The cargo storage system according to claim 9, wherein the accessory may be one or more divider panels that permit a user to customize the load floor cargo area.

12. A cargo storage system for a forward compartment of a vehicle, the cargo storage system comprising:
a support frame having a first folding frame unit and a second folding frame unit; and
a load floor supported upon the first and second folding frame units,
wherein the first and second folding frame units are mountable upon a trunk bin or body-in-white structure of the vehicle, and
wherein the placement of the load floor upon the frame units divides the forward compartment into a load floor cargo area in an area above the load floor, and a sub-floor cargo area in an area below the load floor.

13. The cargo storage system according to claim 9, wherein the load floor is configured as a multi-panel assembly that covers the sub-floor cargo area delimited by the first and second folding frame units of the support frame, the multi-panel assembly having a first panel and a second panel that are hingedly connected at an interface therebetween.

14. The cargo storage system according to claim 10, wherein the first panel is fully foldable upon the second panel, and wherein the folded load floor is removable and repositionable to opposing first and second side pockets provided between rear portions of each folding frame unit and a rear wall of the forward compartment.

15. The cargo storage system according to claim 11, wherein each of the first and second folding frame units include a stationary portion and a moveable forward portion, and wherein upon stowage of the folded load floor in the side pockets, each of the moveable forward portions of the first and second folding frame units are rotated from a deployed position to a stowed position, therein defining opposing extended storage pockets to further retain the folding load floor.

16. A cargo storage system for a forward compartment of a vehicle, the cargo storage system comprising:
a support frame having wall elements including a forward wall, a rearward wall, a first side wall and a second side wall; and
a load floor supported upon the wall elements,
wherein the support frame is mountable upon a trunk bin or body-in-white structure of the vehicle, and
wherein the placement of the load floor upon the support frame divides the forward compartment into a load floor cargo area in an area above the load floor, and a sub-floor cargo area in an area below the load floor, and
wherein the load floor is configured to be hinged and slidable relative to the support frame.
